(19) United States
(12) Patent Application Publication
(10) Pub. No.: US 2010/0192012 A1
(43) Pub. Date: Jul. 29, 2010

(54) TESTING MULTI-CORE PROCESSORS IN A SYSTEM

(75) Inventor: Ishwardutt Parulkar, San Francisco, CA (US)

Correspondence Address: BROOKS KUSHMAN P.C. /Oracle America/ SUN / STK, 1000 TOWN CENTER, TWENTY-SECOND FLOOR, SOUTHFIELD, MI, 48075-1238, US

(73) Assignee: SUN MICROSYSTEMS, INC., Santa Clara, CA (US)

(21) Appl. No.: 12/359,740

(22) Filed: Jan. 26, 2009

(51) Int. Cl. G06F 11/07; G06F 11/22

(52) U.S. Cl. 714/24; 714/25; 714/34; 714/E11.024; 714/E11.023; 714/E11.149

(57) ABSTRACT

An apparatus and method for detecting a defect in a multi-core processor in a system is provided. The apparatus comprises a processor and an operating layer. The processor includes a plurality of cores capable of executing instructions to enable the system to function in a normal operating mode. The operating layer is configured to select at least one first target core from the plurality of cores in the normal operating mode and to test the at least one first target core for a defect while at least one remaining core from the plurality of cores is configured to execute the instructions to enable the system to function in the normal operating mode.

### BACKGROUND

1. Technical Field

One or more embodiments of the present invention generally relate to an apparatus and method for testing multi-core processors in a system.

2. Background Art

Semiconductor chips (or multi-core processors) are susceptible to degradation after being deployed in various systems in the field. During manufacturing, the chips are tested for silicon defects using several techniques and test patterns. Such techniques and/or test patterns may include scan-based Automatic Test Pattern Generation (ATPG), Logic Built-in-Self-Test (BIST), Memory (BIST) and other suitable functional patterns. Such testing spawns across frequency, temperature, and voltage points to ensure that the chips are operational across design requirements. However, the testing is limited to detecting defects that are present in the chip at the time such chips are manufactured.

Semiconductor chips are susceptible to degradation over time as the chips are utilized and stressed within the system in the field. There are several phenomenon that could manifest as defects during chip operation over time. Such phenomenon may include, but not limited to, electromigration, gate oxide breakdown, channel hot carrier effect, and negative bias temperature instability. Electromigration causes voids or opens within the chip due to the diffusion of metal atoms along various conductors. Gate oxide breakdown causes a short condition when a conductive path from a gate of a transistor to its body through the gate-oxide increases leakage current. Channel hot carrier effect occurs when impact ionization is close to the drain of a transistor thereby causing degradation in transistor current. Such a condition may slow the performance of the device. Negative bias temperature instability occurs due to the presence of impurities and the penetration of boron into oxide. Such a condition changes the threshold voltage of a transistor thereby decreasing the operational response of the device.

There are two methods commonly implemented to reduce the occurrence of the defects noted above. In a first method, guardbands may be added in the design and/or while testing. However, the chip degradation may not be completely eliminated with the utilization of guardbands. With chip device dimensions shrinking to 45 and 32 nm, degradation effects may be increasingly more prevalent and the implementation of the various guardbands to mitigate degradation effects may significantly cut into the performance of the chips.

In a second method, on-line testing may be used to reduce chip degradation. However, such testing occurs by concurrent checkers in the design and have been known to include various limitations. Such limitations may include that the (i) checkers generally consumes extra area on silicon and power since the chip is always on, (ii) testing coverage (i.e., the percentage of defects that are capable of being detected) may be low, (iii) checkers cannot be used as predictive detectors because the circuits under test are running concurrently with the checkers, therefore, a failure in the checker is also a failure in the circuit.

### SUMMARY

An apparatus and method for detecting a defect in a multi-core processor in a system is provided. The apparatus comprises a processor and an operating layer. The processor includes a plurality of cores capable of executing instructions to enable the system to function in a normal operating mode. The operating layer is configured to select at least one first target core from the plurality of cores in the normal operating mode and to test the at least one first target core for a defect while at least one remaining core from the plurality of cores is configured to execute the instructions to enable the system to function in the normal operating mode.

### BRIEF DESCRIPTION OF THE DRAWINGS

The embodiments of the present invention are pointed out with particularity in the appended claims. However, other features of the various embodiments will become more apparent and will be best understood by referring to the following detailed description in conjunction with the accompany drawings in which:

FIG. 1 depicts a system for testing a multi-core processor in accordance to one embodiment of the present invention; and

FIG. 2 is a method for testing the multi-core processor in accordance to one embodiment of the present invention.

### DETAILED DESCRIPTION

Detailed embodiments of the present invention are disclosed herein. However, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the one or more embodiments of the present invention.

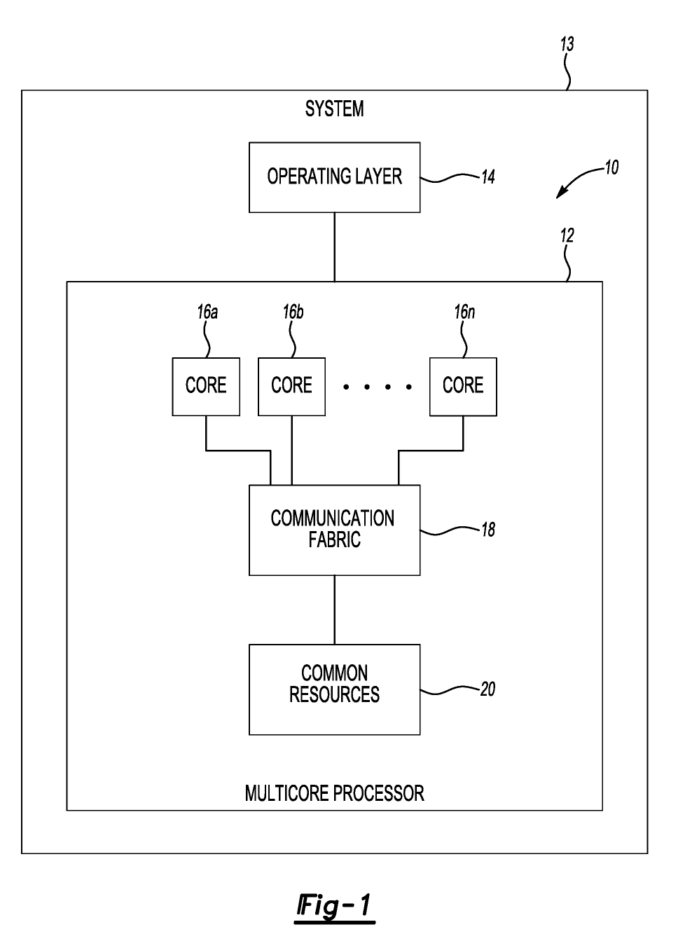

FIG. 1 depicts an apparatus 10 for testing a multi-core processor 12 in a system 13 in accordance to one embodiment of the present invention. The apparatus 10 comprises the multi-core processor 12 and an operating layer 14. The processor 12 includes a plurality of cores 16a-16n. The plurality of cores 16a-16n allows the processor 12 the ability to process multiple operations (or instructions) in parallel thereby increasing the speed in which one or more of the instructions are executed. The processor 12 may include, but not limited to, 16 cores and 256 threads. The particular number of cores and threads contained within the processor 12 may vary based on the desired criteria of a particular implementation. The cores 16a-16n and the threads are generally implemented on a single chip.

The processor 12 further includes a communication fabric 18 and common resources 20. The common resources 20 is generally configured to interface with the operating layer 14 for communicating data to one or more of the cores 16a-16n via the communication fabric 18. The common resources 20 may include, but not limited to, cache, processor I/O, and various system interface mechanisms. The communication fabric 18 serves as a communication mechanism for enabling data transmission between the common resources 20 and the plurality of cores 16a-16n and other such common resources off-chip. In one example, the communication fabric 18 enables the cores 16a-16n to access one or more of a unified level-2 cache, system memory interface, network interface, service management interface or other suitable mechanism.

The operating layer 14 may be implemented as software layer that includes an operating system or firmware. The operating layer 14 is capable of interfacing with the hardware. It is generally recognized that the layer 14 is capable of being executed on a processor. The operating layer 14 may be configured to test the overall system 13 and various electronic components such as the processor 12 after the system has been powered up. In one example, the operating layer 14 may be implemented as Hypervisor or other suitable variant. The system 13 may include, but not limited to, servers, computers, televisions (TV's), DVD players, DVRs, etc. It is generally contemplated that any such system that is configured to process operations in parallel with a microprocessor may include one or more of the processors 12.

The operating layer 14 may employ a Power-On-Self-Test (POST) for testing the cores 16a-16n within the processor 12. POST generally performs simple tasks like checking configurations and IDs (within the cores 16a-16n) to complex tasks such as, but not limited to, running tests to determine if the cores 16a-16n (or other hardware in the apparatus 10) are functional. In various high-end systems (such as, but not limited to, powerful servers used in data centers that adhere to high quality and reliability requirements), the tests employed by the operating layer 14 may include BIST routines for testing the logic of the processor 12 while the system 13 is in the field (or in an operational state with the end-item user). Such BIST routines used in the field may be similar to the tests performed on the processor 12 as the processor 12 is manufactured. The apparatus 10 may test one core while allowing remaining cores to operate to provide the desired functionality for the user.

The workload for performing the operation of the system 13 may be distributed between n-1 out of n cores, where the nth core is in an idle state even if such a core is not being tested. Meaning, that for normal system operation, one core is tested at a time while the remaining cores are capable of processing all of the operations for the system 13 to provide the intended functionality. For example, the operating layer 14 is generally configured to test a single core 16a while allowing the remaining cores 16b-16n to function in operational mode (e.g., perform operational processing or workload application processing). In general, the apparatus 10 may be arranged so that cores 16b-16n on the processor 12 are configured to perform the operational processing for the system 13 while the remaining core (e.g., 16a) that is not active in performing operational processing may be selected for testing. After testing core 16a, the operating layer 14 may shift the workload of core 16b to core 16a. After the workload of core 16b is moved to core 16a, cores 16a and 16c-16n resume operational processing for the system 13 while core 16b is being tested. Once the testing for core 16b is complete, the operating layer 14 may shift the workload of core 16c to 16b. After the workload of core 16c is moved to core 16b, cores 16a-16b and 16d-16n resume operation while core 16c is tested. The operating layer 14 may control the manner in which the core(s) that are in an idle state may be tested while at the same time allow any remaining cores (that are not in an idle state) to operate in normal operational mode to provide the desired functionality for an end user. Such a condition allows the cores 16a-16n to be tested for degradation while in the field and at the same time allow the system 13 to operate for its intended purpose.

While the above example discloses testing a single core at a time, it is recognized that the operating layer 14 may control two or more cores to undergo testing while allowing any remaining cores (i.e., that is not being tested) to resume the intended operation of the system 13 so long as the operational integrity of the system 13 can be maintained with the remaining cores.

In another embodiment, the workload for performing the operation of the system 13 may be distributed between all of the cores so that no core is in an idle state. In such an example, a particular core is selected to be tested and the architectural state of the tested core may be saved in memory or other mechanism capable of storing the state of such a core. The test is performed on the particular core and the remaining cores resume the operation for the system 13. In such an example, all of the silicon (i.e., cores) is utilized for system applications when a test is not scheduled to be performed on the cores. However, individual process performance may go down since chip operation may be stalled while the particular core is being tested.

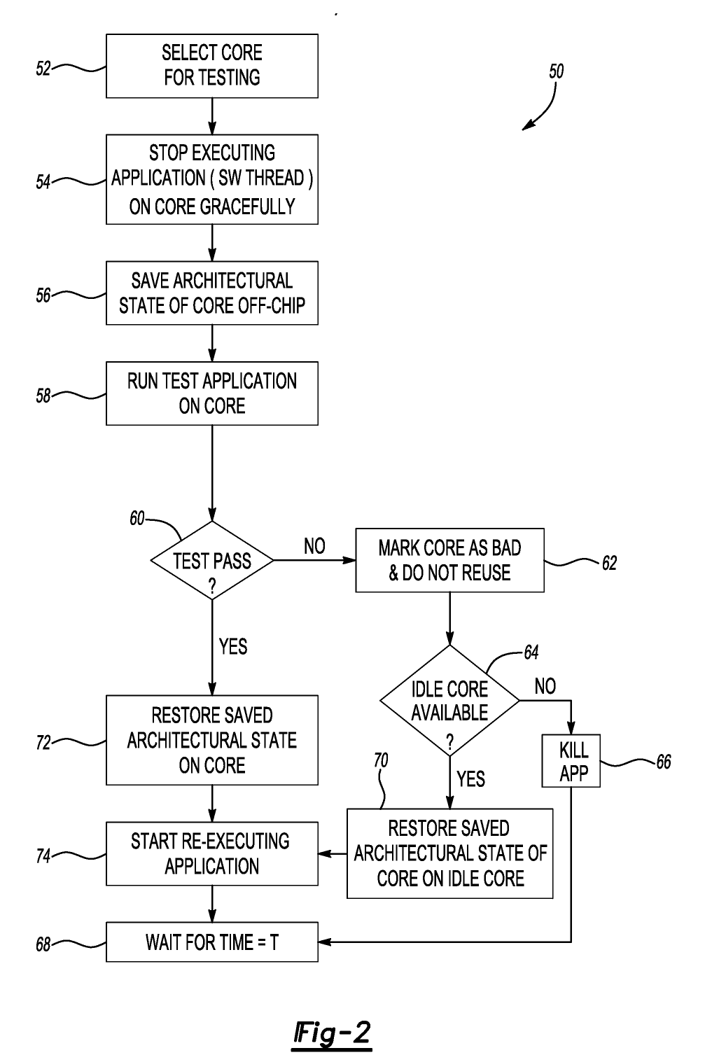

FIG. 2 depicts a method 50 for testing the plurality of cores 16a-16n in the processor 12 in accordance to one embodiment of the present invention.

In operation 52, the operating layer 14 may select a target core from the plurality of cores 16a-16b to be tested. For example, the operating layer 14 may select core 16a as a target core to be tested while allowing the remaining cores 16b-16n to resume workload operations as needed to be performed by the system 13. As noted above, the apparatus 10 and method 50 are not intended to be limited to facilitating the testing of only a single core at a time and allowing the remaining cores to resume the workload operations. It is contemplated that one or more cores may be tested while other such remaining cores may be used to process operations within the system 13. The particular number of cores selected to be tested by the operating layer 14 may vary based on the desired criteria of the particular implementation.

In operation 54, the operating layer 14 controls core 16a to stop executing the current application (or software thread) gracefully. For example, the data pipeline associated with core A may be stalled in response to a “stall” instruction. The operating layer 14 may transmit a control signal to the processor 12 so that the processor 12 by way of the common resources 20 generates the stall instruction.

In operation 56, the operating layer 14 saves the architectural state of core 16a in one or more of the remaining cores 16b-16n or in memory either internal or external to the processor 12. For example, all values of registers associated with core 16a are saved and stored. The operating layer 14 may also track data in the cache lines within the common resources 20 that are associated with core 16a. Such stored data is saved for processing by core 16a after core 16a has been tested.

In operation 58, the operating layer 14 runs a test application on core 16a. In one example, the test application may be a subset of POST called silicon-POST to test a core for silicon degradation. In another example, a BIST may be performed on an instruction-cache in the core. In yet another example, a functional test may be performed on a floating point unit in the core. The type of test application used to test the core may vary based on the desired criteria of a particular implementation. Any foreseeable test, not limited to silicon-POST, BIST or functional test, may be employed to test a particular core.

In operation 60, the operating layer 14 determines whether the core 16a has successfully passed the test. If core 16a has not passed, then the method 50 moves to operation 62. If the core 16a has passed, then the method 50 moves to operation 72.

Operations 62, 64, 66, 68, 70 and 74 are performed in response to the operating layer 14 determining that core A has failed the test.

In operation 62, the operating layer 14 designates core 16a as bad. The operating layer 14 retires the core 16a and will not place the core 16a back into rotation to process system operations. The apparatus 10 may generate a processor error for presentation to the end-item user to notify the end item user that core A is bad.

In operation 64, the operating layer 14 determines whether an idle core (from the cores 16b-16n) is available. An idle core is generally defined as a core that is not being utilized to process operations. In general, if one core has been determined to be bad, then there is no idle core available to receive workload from a good core that needs to be tested. If the operating layer 14 determines that an idle core is not available, then the method 50 moves to operation 66. If the operating layer 14 determines that an idle core is available, then the method 50 moves to operation 70.

In operation 66, the operating layer 14 controls the remaining cores 16b-16n to stop processing operations or applications for the system 13.

In operation 68, the operating layer 14 waits for a predetermined amount of time t, of the controlling the remaining cores 16b-16n to stop processing operations or applications for the system 13. In general, it may not be necessary to test the cores often for degradation. In one example, the time needed to test a core may take a few seconds. However, it may not be optimal to perform a test once in a few hours. As such, time t is programmable so that the time can be modified so that the optimal level of testing may be performed for a given system.

In operation 70, the operating layer 14 restores the saved architectural state of the core 16a on the idle core. For example, the operating layer 14 moves all values of registers associated with core A and various cache lines associated with core 16a to the idle core since core 16a has failed the test.

In operation 74, the operating layer 14 controls the idle core to work with the remaining cores 16b-16n to process operations for the system 13.

In operation 68, the operating layer 14 waits a predetermined amount of time, t, after controlling the idle core to work with the remaining cores 16b-16n to process operation for the system 13. The operating layer 14 may wait for the same reasons presented above.

Operations 72, 74 and 68 are performed in response to the operating layer 14 determining that core 16a has successfully passed the test.

In operation 72, the operating layer 14 restores the architectural state of core 16a. For example, the operating layer 14 moves all values of the registration associated with core 16a and the various cache lines associated with core 16a that are stored elsewhere within the system 13 back to core 16a.

In operation 74, the operating layer 14 controls core 16a to resume processing operations for the system 13.

In operation 68, the operating layer 14 waits for a predetermined amount of time, t. Operation 68 may be optimal. For example, it may be efficient to have to have core 16a complete the test and then sit idle for the predetermined amount of time prior to selecting the next core 16b-16n and saving the architectural state of the next core 16b-16n in the event the time needed to run the test on a corresponding core is smaller than selecting and saving the architectural state of the next core 16b-16n. The operating layer 14 may wait for the same reasons presented above.

After completing operation 68, the method 50 re-executes itself so that all of the cores are ultimately tested. The method 50 may be employed while the system 13 is operating in its normal operating mode. The method 50 may be executed over the life of the system 13. It is recognized that the operating layer 14 may be configured in any foreseeable arrangement to test one or more of the cores 16a-16n. For example, the operating layer 14 may test all of the cores 16a-16n after the system 13 is powered on or after the system 13 experiences a power on reset. The operating layer 14 may also be arranged to test one or more of the cores 16a-16n at pre-defined intervals as defined or established by the end item user. Such a condition may allow the testing of the cores 16a-16n when system operation is expected to be low or in moments of low processing overhead.

The apparatus 10 and method 50 may detect silicon degradation (or other latent defects) during the lifetime of a multi-core processor 12 that may cause a malfunction of a corresponding end item system. The apparatus 10 and method 50 are arranged such that the testing of the cores 16a-16n are performed in a manner that is transparent to the operation of the system 13. It is generally contemplated that every transistor on a given core 16a-16n is tested and that a focused, high coverage test can be performed since all of the resources belonging to each core 16a-16n are generally available for testing. It is not necessary for the system 13 to have to be shut down or operationally disabled in order for the cores 16a-16n to be tested. The apparatus 10 does not generally entail chip design or verification complexity (i.e., makes use of existing hardware capabilities with relatively minor changes).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An apparatus for detecting a defect in a multi-core processor in a system, the apparatus comprising:
a processor including a plurality of cores capable of executing instructions to enable the system to function in a normal operating mode; and
an operating layer configured to select at least one first target core from the plurality of cores in the normal operating mode and to test the at least one first target core for a defect while at least one remaining core from the plurality of cores is configured to execute the instructions to enable the system to function in the normal operating mode.

2. The apparatus of claim 1 wherein the operating layer is further configured to control the at least one first target core to gracefully stop executing instructions prior to testing the at least one first target core.

3. The apparatus of claim 1 further comprising memory positioned off of the processor and within the system, wherein the operating layer is further configured to move an architectural state that is associated with the at least one first target core to one of the memory and the at least one remaining core prior to testing the at least one first target core.

4. The apparatus of claim 3 wherein the operating layer is further configured to restore the architectural state from the one of the memory and the at least one remaining core so that the architectural state is associated with the at least one first target core in the event the operating layer determines that the at least one first target core is free of the defect.

5. The apparatus of claim 1 wherein the operating layer is further configured to retire the at least one first target core so that the at least one first target core is not capable of executing instructions in response to the operating layer determining that the at least one first target core has failed the test.

6. The apparatus of claim 1 wherein the operating layer is further configured to select at least one second target core from the plurality of cores in the normal operating mode and to test the at least second target core for a defect while the at least one first target core and the at least one remaining core from the plurality of cores are configured to execute instructions to enable the system to function in the normal operating mode in response to detecting the presence of the failure on the at least one first target core.

7. The apparatus of claim 1 wherein the operating layer is configured to test the at least one first target core with a silicon power on self test for silicon degradation.

8. A method for detecting a defect in a multi-core processor of a system, the method comprising:
executing instructions, with a processor including a plurality of cores, to enable the system to function in a normal operating mode; and
selecting at least one first target core from the plurality of cores in the normal operating mode; and
testing the at least one first target core for a defect while at least one remaining core from the plurality of cores executes instructions to enable the system to function in the normal operating mode.

9. The method of claim 8 wherein selecting the at least one first target core further comprises controlling the at least one first target core to gracefully stop executing instructions prior to testing the at least one first target core.

10. The method of claim 8 wherein selecting the at least one first target core further comprises moving an architectural state that is associated with the at least one first target core to one of memory positioned off of the processor and the at least one remaining core prior to testing the at least one first target core.

11. The method of claim 10 wherein testing the at least one first target core further comprises restoring the architectural state from the one of the memory and the at least one remaining core so that the architectural state is associated with the at least one first target core in the event the at least one first target core is detected to be free of the defect.

12. The method of claim 8 further comprising retiring the at least one first target core so that the at least one first target core is not capable of executing instructions in response to detecting the presence of the defect on the at least one first target core.

13. The method of claim 8 further comprising selecting at least one second target core from the plurality of cores in the normal operating mode; and
testing the at least second target core for a defect while the at least one first target core and the at least one remaining core from the plurality of cores execute instructions to enable the system to function in the normal operating mode in response to determining that the at least one first target core is free of the defect.

14. The method of claim 8 wherein testing the at least one first target core further comprises testing the at least one first target core with a silicon power on self test for silicon degradation.

15. An apparatus for detecting a defect in a system with an operating layer, the apparatus comprising:
a processor including a plurality of cores capable of executing instructions to enable the system to function in a normal operating mode;
at least one first target core from the plurality of cores for selection by the operating layer in the normal operating mode so that the at least one first target is tested for a defect; and
at least one remaining core from the plurality of cores being configured to execute the instructions to enable the system to function in the normal operating mode while the at least one first target core is being tested.

16. The apparatus of claim 15 further comprising at least one second target core from the plurality of cores for selection by the operating layer in the normal operating mode so that the at least one second target core is tested for a defect.

17. The apparatus of claim 16 wherein the at least one first target core and the at least one remaining core are configured to execute the instructions to enable the system to function in the normal mode while the at least one second target core is being tested.

18. The apparatus of claim 15 wherein the at least one first target core is tested with a silicon power on self test for silicon degradation.
